(19) United States
(12) Patent Application Publication
(10) Pub. No.: US 2015/0302940 A1
(43) Pub. Date: Oct. 22, 2015

(54) Electromagnetic Matter Injector and Capsule System

(71) Applicant: University of Washington through its Center for Commercialization, Seattle, WA (US)

(72) Inventor: Roger Raman, Franklin Park, NJ (US)

(21) Appl. No.: 14/383,736

(22) PCT Filed: Mar. 11, 2013
(86) PCT No.: PCT/US13/30239

§ 371 Date: Sep. 8, 2014

Related U.S. Application Data
(60) Provisional application No. 61/628,873, filed on Nov. 9, 2011.

(51) Int. Cl. G21B 1/15

(52) U.S. Cl. CPC G21B 1/15

(57) ABSTRACT

A system (100) for injecting particulate (110) matter into a reaction vessel is disclosed. An electromagnetic injector includes a first rail electrode (122), a second rail electrode (124), and an acceleration chamber (126) having sidewalls formed at least in part by the first and second rail electrodes. An injectable capsule (110) is configured to be loaded in the acceleration chamber (126) of the electromagnetic injector so as to be disposed between the first and second rail electrodes (122, 124). The injectable capsule (110) includes a conductive portion arranged so as to convey electrical current between the first rail electrode and the second rail electrode while the injectable capsule is loaded. An electric potential is applied between the first rail electrode (122) and the second rail electrode (124) such that current flows from the first rail electrode to the second electrode, and through the conductive portion of the injectable capsule (110), thereby causing the injectable capsule (110) to accelerate within the acceleration chamber.

### CROSS-REFERENCE TO RELATED APPLICATIONS

This application claims the benefit of U.S. Provisional Patent Application No. 61/608,873, filed Mar. 9, 2012, the content of which is incorporated herein by reference in its entirety.

### STATEMENT REGARDING FEDERALLY SPONSORED RESEARCH OR DEVELOPMENT

This invention was made with government support under DE-SC000675 awarded by the Department of Energy. The government has certain rights in the invention.

### BACKGROUND

Unless otherwise indicated herein, the materials described in this section are not prior art to the claims in this application and are not admitted to be prior art by inclusion in this section.

Fusion is the process of combining two nuclei together. When two nuclei of elements with atomic numbers less than iron are fused energy is released. The release of energy is due to a slight difference in mass between the reactants and the products of the reaction and is governed by ΔE=Δmc². The fusion reaction requiring the lowest plasma temperature occurs between deuterium, a hydrogen atom with an extra nucleus, and tritium, a hydrogen atom with two extra nuclei. This reaction creates a helium atom and a neutron.

One approach for achieving thermonuclear fusion is to energize a gas containing fusion reactants inside a reactor chamber. The energized gas becomes a plasma upon becoming ionized. To achieve conditions with high enough temperatures and densities for fusion the plasma needs to be confined. Magnetic confinement keeps plasmas away from chamber walls because charged particles in the plasma (e.g., electrons and ions) tend to follow magnetic field lines. There are several devices in operation or under development exploring the possibility of magnetic confinement for thermonuclear fusion, including: spheromaks, tokamaks, stellarators, reversed-field pinches (RFP), field-reversed configurations (FRC) and z-pinches. On example of such a magnetic confinement device is the International Thermonuclear Experimental Reactor (ITER) now under construction.

While the geometries of the device configurations vary, generally a torus-shaped reactor chamber is used to enclose the plasma. The plasma can be both energized and urged to circulate around the torus-shaped chamber to create a toroidal current by a number of techniques. For example, incident radio frequency radiation and/or neutral beams can be used to selectively transfer momentum to particles in the plasma. A toroidal magnetic field, such as generated by conductive coils wrapped poloidally around the torus-shaped chamber, steers the plasma circulating in the torus-shaped chamber and prevents interference with the chamber walls. Coils may also be wrapped around such a torus-shaped confinement chamber in a toroidal direction to generate fields in a poloidal direction. Additionally, the current of the circulating plasma and/or additional electromagnetic coils may create a magnetic field in the poloidal direction of the torus-shaped chamber. Plasma in such a chamber is therefore guided according to the combination of externally generated fields and any self-generated magnetic fields, if present.

In magnetic confinement devices that rely on substantial amounts of plasma current to sustain the plasma discharge, conditions may occur when the plasma magnetically contained within the reaction vessel can go unstable. When this happens, it is necessary that the discharge be safely and quickly terminated. Otherwise, large localized damage could occur inside the reaction vessel. Predicting and controlling such disruptions is therefore an important and urgent issue for designers of such magnetic confinement devices.

### SUMMARY

Some embodiments of the present disclosure provide a system. The system can include at least one electromagnetic accelerator including: (i) a first rail electrode, (ii) a second rail electrode, and (iii) an acceleration chamber having sidewalls formed at least in part by the first and second rail electrodes. The system can include a capsule configured to be loaded in the acceleration chamber of the at least one electromagnetic accelerator so as to be disposed between the first and second rail electrodes. The capsule can include a conductive portion arranged so as to convey electrical current between the first rail electrode and the second rail electrode while the capsule is loaded. The system can include a control system configured to (i) receive an indication to activate the at least one electromagnetic accelerator, and (ii) responsive to receiving the indication, cause an electric potential to be applied between the first rail electrode and the second rail electrode such that, when the capsule is loaded, current flows from the first rail electrode to the second electrode, and through the conductive portion of the capsule, thereby causing the capsule to accelerate within the acceleration chamber.

Some embodiments of the present disclosure provide a method. The method can include receiving an indication to activate at least one electromagnetic accelerator including (i) a first rail electrode, (ii) a second rail electrode, and (iii) an acceleration chamber having sidewalls formed at least in part by the first and second rail electrodes. The method can include activating at least one electromagnetic accelerator in response to receiving the indication. The at least one electromagnetic accelerator can be activated by causing an electric potential to be applied between the first and second rail electrodes such that current flows from the first rail electrode to the second electrode, and through a conductive portion of a capsule configured to be loaded in the acceleration chamber so as to be disposed between the first and second rail electrodes, thereby causing the capsule to accelerate within the acceleration chamber.

Some embodiments of the present disclosure provide a non-transitory computer-readable medium storing instructions that, when executed by one or more processors in a computing device, cause the computing device to perform operations. The operations can include receiving an indication to activate at least one electromagnetic accelerator including (i) a first rail electrode, (ii) a second rail electrode, and (iii) an acceleration chamber having sidewalls formed at least in part by the first and second rail electrodes. The operations can include activating the at least one electromagnetic accelerator in response to receiving the indication. The at least one electromagnetic accelerator can be activated by causing an electric potential to be applied between the first and second rail electrodes such that current flows from the first rail electrode to the second electrode, and through a conductive portion of a capsule configured to be loaded in the acceleration chamber so as to be disposed between the first and second rail electrodes, thereby causing the capsule to accelerate within the acceleration chamber.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1A is a functional block depicting an example electromagnetic accelerator system.

FIG. 1B is a functional block diagram depicting activation of the example electromagnetic accelerator system shown in FIG. 1A.

FIG. 2 is a functional block diagram of another example electromagnetic accelerator system.

FIG. 3A is an aspect view of an example capsule.

FIG. 3B is a cross-sectional view of an example capsule that includes a conductive plate.

FIG. 3C is a cross-sectional view of the example capsule depicting two sections joined during assembly.

FIG. 4A is a cross-sectional view of an example electromagnetic accelerator system having co-axially arranged rail electrodes.

FIG. 4B is a cross-sectional view of the example electromagnetic accelerator system with co-axially arranged rail electrodes that also includes a gas insertion system.

FIG. 5 depicts the electromagnetic injector system of FIG. 4 connected to an example plasma fusion reaction vessel.

FIG. 6 is a flowchart for an example process that may be performed by the system in FIG. 5.

FIG. 7 is a timing diagram for an example operation of the process in FIG. 6.

FIG. 8 depicts plots of various parameters during an example operation of the process in FIG. 6.

FIG. 9 depicts a fragmentation cone situated to receive the capsule.

FIG. 10 depicts a narrowed channel at an end of the acceleration chamber from which the capsule emerges.

FIG. 11 depicts a computer-readable medium configured according to an example embodiment.

### DETAILED DESCRIPTION

### 1. Introduction

The present systems and methods will now be described with reference to the figures. It should be understood, however, that numerous variations from the depicted arrangements and functions are possible while remaining within the scope and spirit of the claims. For instance, one or more elements may be added, removed, combined, distributed, substituted, re-positioned, re-ordered, and/or otherwise changed. Further, where this description refers to one or more functions being implemented on and/or by one or more devices, one or more machines, and/or one or more networks, it should be understood that one or more of such entities could carry out one or more of such functions by themselves or in cooperation, and may do so by application of any suitable combination of hardware, firmware, and/or software. For instance, one or more processors may execute one or more sets of programming instructions as at least part of carrying out of one or more of the functions described herein.

### 2. Example Electromagnetic Accelerator Systems

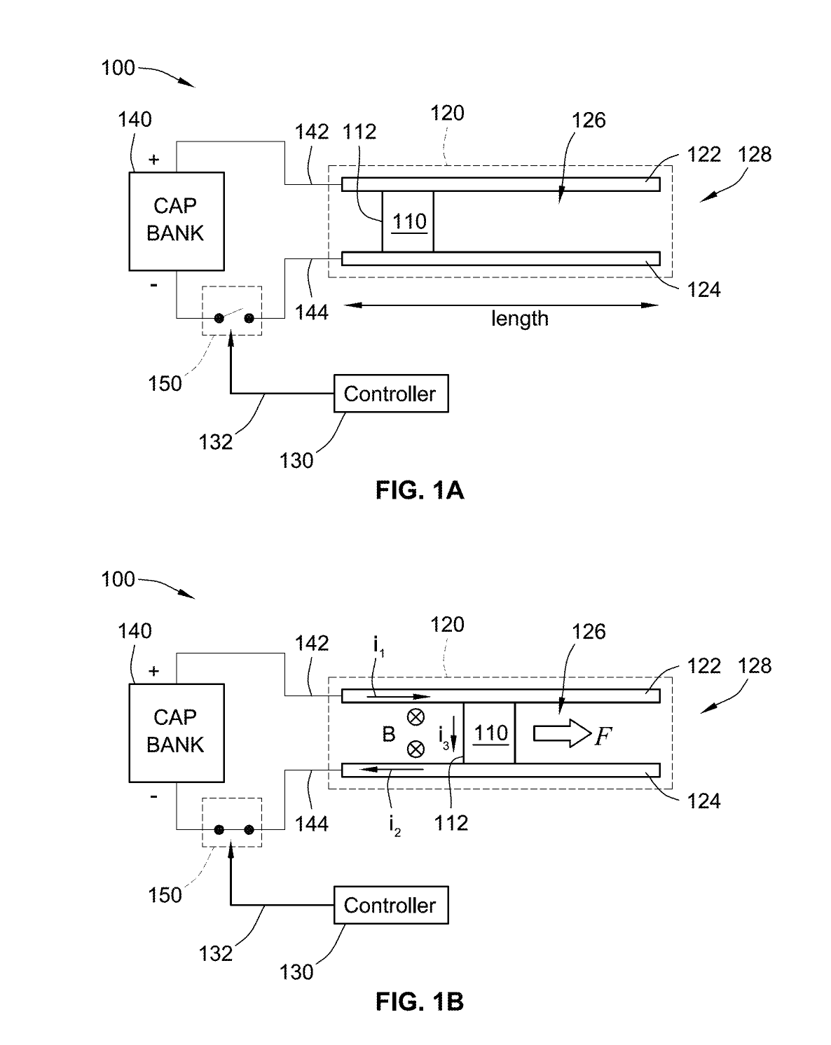

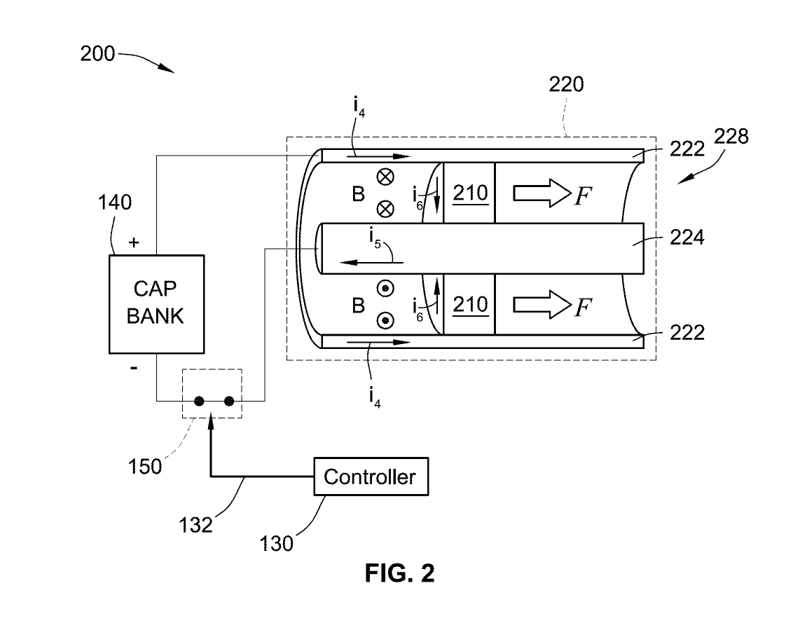

FIGS. 1-2 depict functional block diagrams of example electromagnetic accelerator systems. The example system 100 shown in FIGS. 1A and 1B includes an electromagnetic accelerator 120, a capsule 110, a controller 130, and a capacitor bank 140.

The electromagnetic accelerator 120 includes a first rail electrode 122 and a second rail electrode 124. The rail electrodes 122, 124 extend along a length of the accelerator 120 to define inner side walls of an acceleration chamber 126 (or portions of such inner side walls). The surfaces of the two rail electrodes 122, 124 that define the inner side walls of the acceleration chamber 126 can be electrically conductive and may face toward one another.

The capsule 110 is shaped so as to be disposed in the acceleration chamber 126, between the two rail electrodes 122, 124. The capsule 110 can include an electrically conductive portion 112 that is arranged to convey current between the two rail electrodes 122, 124 when the capsule is loaded in the acceleration chamber 126. For example, the capsule's 110 conductive portion 112 may include a conductive coating and/or conductive plate that is situated to simultaneously contact (or nearly contact) the conductive surfaces of the two rail electrodes 122, 124, and thereby allow electrical current to flow between the two rail electrodes 122, 124, through the conductive portion 112 of the capsule 110. The conductive portion 112 of the capsule 110 may therefore span the acceleration chamber 126 by extending transverse to the respective conductive surfaces of the rail electrodes 122, 124. Moreover, to facilitate electrical connection between the conductive portion 112 and the two rail electrodes 122, 124, the conductive portion 112 may extend along at least a portion of sides of the capsule 110 that interface with the conductive surfaces of the rail electrodes 122, 124.

The two rail electrodes 122, 124 may extend substantially in parallel along the length of the accelerator 120 such that a separation distance between the two, and thus a width of the acceleration chamber 126, is substantially constant throughout the acceleration chamber 126. As such, the capsule 110 may convey electrical current between the two rail electrodes 122, 124 (via the conductive portion 112) while situated at various positions along the length of the acceleration chamber 126. In some examples, the two rail electrodes 122, 124 may be symmetric, with respect to one another, about a mirror reflection plane bisecting the acceleration chamber 126 along the length of the accelerator 120. For example, the two rail electrodes 122, 124 (or at least the inward-facing conductive surfaces thereof) may each be substantially flat, elongated plates with conductive surfaces facing one another. In another example, the two rail electrodes 122, 124 (or at least the inward-facing conductive surfaces thereof) may be curved plates with complementary inward/outward curvature, such as complementary length-wise sections of an inner cylindrical sidewall.

The rail electrodes 122, 124 can be connected to respective terminals of the capacitor bank 140 via respective electrical connectors 142, 144 that are interrupted by at least one switch 150. It is noted that the switch 150 is illustrated by way of example only as a single switch element interrupting the electrical connection 144 connected to the second rail electrode 124, but some embodiments may include additional switches, such as one(s) interrupting the electrical connector 142 connected to the first rail electrode 122 and/or one(s) in series with the first switch 150 so as to increase the resistivity of the electrical connection 144 when both switches are open. The switch 150 (or group of switches) is configured to operate according to instructions 132 from the controller 130. Thus, upon suitable instructions 132 from the controller 130, the switch 150 can be operated so as to apply a voltage stored on the capacitor bank 140 across the two rail electrodes 122, 124. As shown in FIG. 1A, the switch 150 is in an open position and thus the voltage stored on the capacitor bank 150 is not being applied across the two rail electrodes 122, 124.

The capacitor bank 140 can include an arrangement of multiple capacitors, connected in parallel so as to develop a large effective capacitance. The capacitor bank 140 can be charged by, for example, applying voltage to the capacitor bank from a suitable power supply, which may include one or more rectifiers, one or more transformers and the like. The capacitor bank 140 can be charged to a maximum stored energy over some period of time. In some examples, the charging of the capacitor bank may be carried out in accordance with instructions from the controller 130. Once charged, the capacitor bank 140 can be connected to the two rail electrodes 122, 124 (e.g., by closing the switch 150) to apply the electric potential developed on the capacitor bank 140 (i.e., the stored voltage) across the rail electrodes 122, 124. As discussed next, connecting the capacitor bank 140 across the two rail electrodes 122, 124 causes the capacitor bank 140 to discharge through the rail electrodes, and thereby cause current to flow between the two rail electrodes 122, 124, through the capsule 110.

As will be appreciated, the capacitor bank 140 is provided as one example of an energy storage module that can be charged with an electric potential and then discharged to cause current to flow between the rail electrodes 122, 124. For instance, some embodiments may use a single, un-banked capacitor, a battery, or another energy storage module configured to be charged with an electric potential and then discharge such electric potential on a relatively short timescale to create current flowing between the rail electrodes 122, 124, through the capsule 110. Moreover, some embodiments may even use a direct current source that is not pre-charged, and may apply such a current source to the rail electrodes 122, 124 so as to cause current to flow between the rail electrodes 122, 124, through the capsule 110.

In FIG. 1B the switch 150 is in a closed position and thus the voltage stored on the capacitor bank 140 is applied across the two rail electrodes 122, 124. As shown in FIG. 1B, the first rail electrode 122 may be connected (via connector 142) to a positive terminal of the capacitor bank 140 and the second rail electrode 124 may be connected (via connector 144) to a negative terminal of the capacitor bank 140. Once the switch 150 is closed, the electric potential stored on the capacitor bank 140 is applied across the two rail electrodes 122, 124 and the first rail electrode 122 is at a relatively higher voltage than the second rail electrode 124. The capacitor bank 140 begins discharging, which causes current to flow through the electrical connectors 142, 144, the rail electrodes 122, 124, and the conductive portion 112 of the capsule 110. The current through the rail electrodes 122, 124 induces magnetic fields within the acceleration chamber 126, and the capsule 110 is urged to move within the acceleration chamber 126 by the magnetic interaction between the induced magnetic fields and the current through its conductive portion 112.

FIG. 1B includes an example of generated currents and resulting magnetic fields that occur after closing the switch 150 in the case where the first rail electrode 122 is connected to a positive terminal of the capacitor bank and the second rail electrode 124 is connected to a negative terminal. As shown in FIG. 1 B, current with direction labeled by i₁ flows through the first rail electrode 122, away from the first electrical connector 142 and toward the capsule 110. Meanwhile, current with direction labeled by i₂ flows through the second rail electrode 124 away from the capsule 110 and toward the second electrical connector 144. The current within the two electrodes 122, 124 (i.e., the currents i₁ and i₂) may therefore be oriented in opposite (anti-parallel) directions. Current with direction labeled by i₃ completes the circuit by flowing through the conductive portion 112 of the capsule 110, from the first rail electrode 122 to the second rail electrode 124. As viewed in FIG. 1B, the current i₁ in the first rail electrode 122 is directed from left to right, the current i₂ in the second rail electrode 124 is directed from right to left, and the current i₃ conveyed through the capsule 110 is directed from top to bottom. The current i₁ through the first rail electrode 122 generates a magnetic field that coils around the first rail electrode 122 and is directed into the page within the acceleration chamber 126 (i.e., the region near the capsule 110). Similarly, the current i₂ through the second rail electrode 124 generates a magnetic field that coils around the second rail electrode 124 and is directed into the page within the acceleration chamber 126 (i.e., the region near the capsule 110). The currents through two rail electrodes 122, 124 thus combine to provide a magnetic field B within the acceleration chamber 126 that is directed into the page, as shown in FIG. 1B.

The capsule 110 (and its conductive portion 112) is therefore situated in a region with magnetic field directed into the page, and the downward directed current i₃ creates a force, labeled by directional arrow F in FIG. 1B, that urges the capsule 110 through the acceleration chamber 126 toward the end 128. The capsule 110 is accelerated through the chamber 126 by a Lorentz force given by a cross-product relationship between the current through the conductive portion 112 of the capsule 110 (e.g., the current i₃ directed downward) and the induced magnetic fields (e.g., the fields B directed into the page). The end 128 of the accelerator 120 toward which the capsule 110 is urged (and from which the capsule 110 eventually emerges) can be at end opposite to the one connected to the capacitor bank 140 via the electrical connectors 142, 144.

In some embodiments, the first and second rail electrodes 122, 124 can be connected to the opposite terminals of the capacitor bank 140 (e.g., the first rail electrode 122 may be connected to a negative terminal of the capacitor bank 140, and the second rail electrode 124 may be connected to a positive terminal of the capacitor bank 140). In such an example, closing the switch 150 following charging the capacitor bank, results in a discharge current flowing between the two rail electrodes 122, 124, and through the capsule 110, with current directions opposite to the directions labeled by i₁, i₂, and i₃ (e.g., the current through the capsule 110 is directed upward, rather than downward). However, due to the reversed current directions, the direction of the induced magnetic field B in the acceleration chamber 126 is also reversed (e.g., the magnetic field B in the region near the capsule 110 is directed out of the page, rather than into the page). As a result, the electromagnetic interaction between the current-carrying conductive portion 112 of the capsule 110 and the induced magnetic fields B results in urging the capsule 110 through the acceleration chamber 126, toward the end 128, regardless of the current direction.

FIG. 2 depicts an example of another electromagnetic accelerator system 200 with co-axial rail electrodes. The system 200 operates similarly to the system 100 of FIG. 1, and includes the controller 130 configured to operate the switch 150 so as to discharge the capacitor bank 140 across a co-axial electromagnetic accelerator 220, so as to accelerate a capsule 210 disposed in the accelerator 220.

The co-axial accelerator 220 includes an outer rail electrode 222 and an inner rail electrode 224, which are connected to respective terminals of the capacitor bank 140. The co-axial electrodes 222, 224 can each include electrically conductive materials, at least along respective facing surfaces that define the inner side walls of the acceleration chamber (e.g., the annular region between an inner surface of the outer rail electrode 222 and an outer surface of the inner rail electrode 224). Closing the switch 150 thus applies the voltage charged on the capacitor bank 140 across the rail electrodes 222, 224 and thereby causes a discharge current to flow between the electrodes 222, 224, through the capsule 210.

In an example, the outer rail electrode 222 may be connected to a positive terminal of the capacitor bank 140 while the inner rail electrode 224 may be connected to a negative terminal of the capacitor bank 140. Closing the switch 150 so as to discharge the capacitor bank 140 thus results in current with direction indicated by i₄ that flows through the outer rail electrode 222, toward the capsule 210. Meanwhile, current with direction labeled by i₅ flows through the inner rail electrode 224, away from the capsule 210. The respective currents carried by the co-axial rail electrodes 222, 224 (i.e., the currents i₄ and i₅) may therefore be oriented in opposite (anti-parallel) directions. A conductive portion of the capsule 210 conveys current (with direction indicated by i₆) between the two rail electrodes 222, 224 to complete the circuit. The current i₆ conveyed through the capsule 210 is directed radially inward, from the outer rail electrode 222 to the inner rail electrode 224.

The current flowing through the rail electrodes 222, 224 generates a magnetic field that coils around the inner rail electrode 224. As shown in the FIG. 2, with current i₅ on the inner rail electrode 224, the magnetic field coils around the inner rail electrode 224 and is directed into the page in the region above the inner rail electrode 224 and out of the page below the inner rail electrode 224. The radially-inward current i₆ through the capsule 210 interacts with the induced magnetic field to urge the capsule 210 to move toward the end 228 of the accelerator 220. The direction of the magnetic force urging the capsule 210 to accelerate toward the end 228 is shown the block arrows F. The force F can be a Lorentz force directed according to a cross product between the radially-inward current i₆ and the induced magnetic field that coils around the inner rail electrode 224.

The co-axial electrodes 222, 224 can be situated to be at least approximately cylindrically symmetric with respect to a common axis, such as an axis extending along the length of the accelerator 220, through the center of the inner rail electrode 224. For instances, the inner rail electrode 224 can be a substantially solid cylinder with a conductive outer surface forming the inner side wall of the accelerator's 220 annular acceleration chamber. The outer rail electrode 222 may be a hollow shell with conductive inner side walls facing the inner rail electrode 224. The respective conductive surfaces of the co-axial rail electrodes 222, 224 can then be contacted by a conductive portion of the capsule 210.

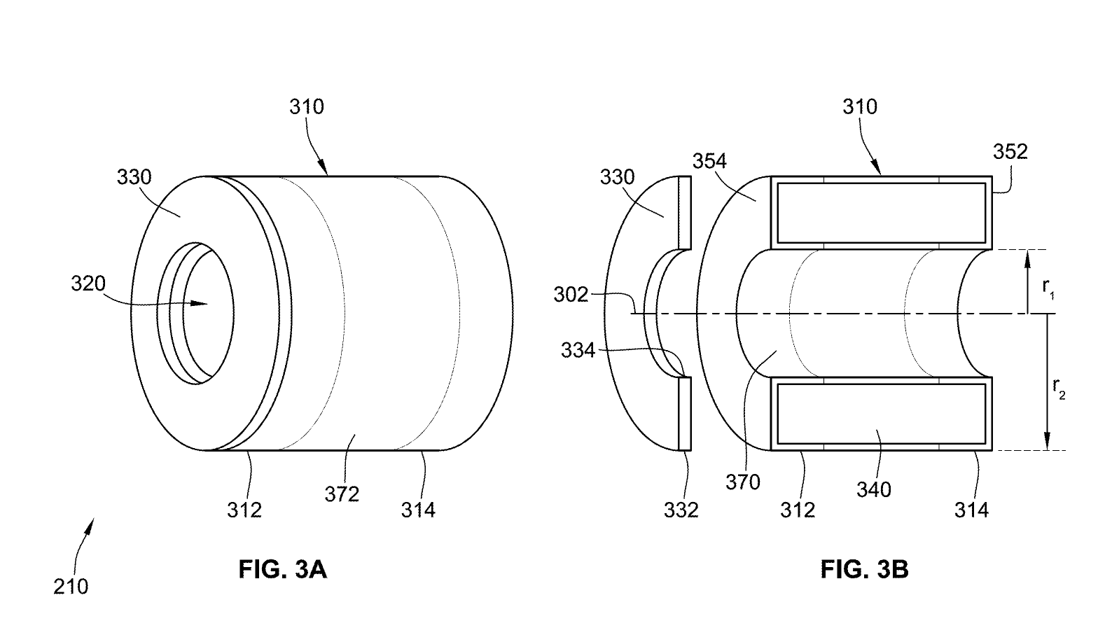

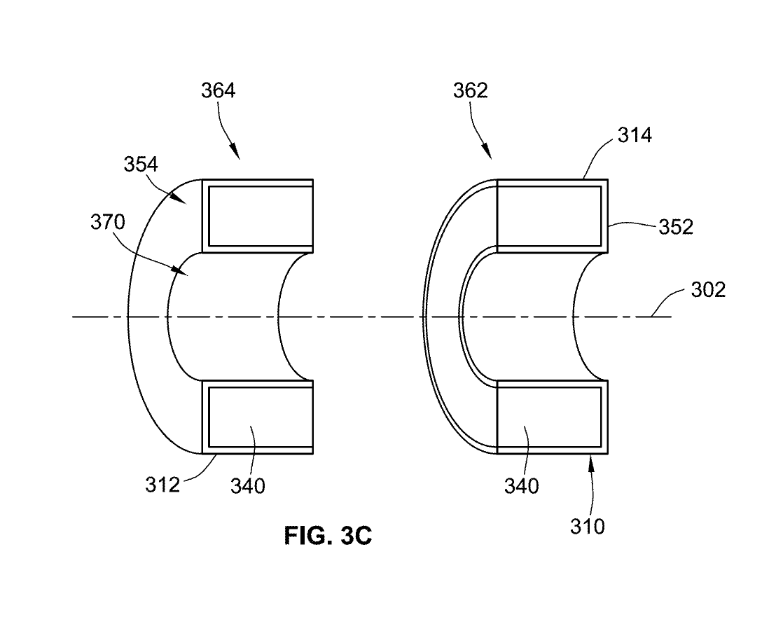

The capsule 210 can be shaped to be situated in the annular acceleration chamber defined by the co-axial rail electrodes 222, 224. Thus, the capsule 210 can have a central aperture suitable to receive the inner rail electrode 224 when the capsule 210 is loaded in to the acceleration chamber. The capsule 210 may have a general shape similar to a toroid and/or a hollow cylindrical shell open at either end, and with radial thickness configured to span the acceleration chamber between the two rail electrodes 222, 224. An example arrangement of the annular capsule 210 is described further below in connection with FIG. 3.

The systems 100, 200 thus provide example architectures for electromagnetic accelerators that can be used to accelerate capsules 110, 210 according to control signals from a controller 130. In some embodiments, the accelerators 100, 200 may be mounted to a reaction vessel and arranged so as to accelerate capsules into the reaction vessel, upon exit from the accelerator 100, 200. The systems 100, 200 may therefore be used to deliver materials to a reaction vessel (e.g., materials in the capsule 110, 210) according to control signals 132 from the controller 130, and the capsules may then be injected into the reaction vessel. For example, the system 100, 200 may be connected to a confinement chamber of a plasma fusion reactor, and the capsule 110, 210 may be injected into the confinement chamber to deliver, for example, a thermal energy quenching agent. In another example, the system 100, 200 may be connected to a chemical reaction chamber, and the capsule 110, 210 may be injected into the reaction chamber to deliver, for example, a catalyst and/or a reactant, etc. to facilitate the chemical reaction.

In some embodiments of the present disclosure, the systems 100, 200 are used to inject capsules into reaction vessels with low latency to achieve desired response times. The controller 130, switch 132, and/or capacitor bank 140 can therefore be configured to enable rapid activation of the accelerator 120, 220, upon the controller 130 receiving an indication to activate. The controller 130 may be configured to operate the switch 150 to cause the electric potential on the capacitor bank 140 to be applied across the rail electrodes, and the switch 150 may be selected to provide desired high speed performance. Accordingly, the switch 150 may be selected to respond on timescales less than, for example, 10 milliseconds, 5 milliseconds, 1 millisecond, and/or other timing requirements.

Generally, the system 100, 200 may have target response time in which to cause the capsule 110, 210 to emerge from the accelerator 120, 220 within a desired length of time following a determination to activate the system 100, 200. The response time may thus include: (i) any time delay between the controller 130 receiving an indication to activate the system and the controller 130 sending the instructions 132; (ii) any time delay between sending the instructions 132 and the switch 150 being operated; and (iii) any time delay between the operation of the switch 150 and the capsule 110, 210 emerging from the accelerator 120, 220. Accordingly, various components in the system 100, 200 may be configured to reduce and/or mitigate the effect(s) of such time delays. For example, the controller 130 may be configured to determine, on an ongoing basis, whether to activate the system and, if so, send the instructions 132 in less than 1 millisecond. Similarly, the switch 150 may be selected to provide low latency operation upon receiving the instructions 132. Additionally or alternatively, parameters for the capacitor bank 140, the capsule 110, 210, and the accelerator 120, 220 may be tuned to achieve a desired total response time of the system 100, 200. For example, the system 100, 200 may be configured to provide a response time less than 10 milliseconds, or less than 5 milliseconds, or can provide another desired level of time responsiveness.

As an example, the time responsiveness of the system 100, 200 may also be influenced by the amount of acceleration applied to the capsule 110, 210 (i.e., the amount of electromagnetic force generated and the mass of the capsule), and the length of the acceleration chamber. The applied electromagnetic force is in turn influenced by the amount of current provided from the capacitor bank 140. Thus, the accelerator length, the capsule mass, and/or the capacitance and/or charging voltage of the capacitor bank 140 may be selected to provide an adequate discharge current to accelerate the capsule 110, 210 all the way through the length of the accelerator 120, 220 within a desired timescale. For instance, the capacitance of the capacitor bank 140, which affects the discharge duration, may be selected on the basis of the length of the accelerator chamber and/or other parameters such as the mass of the capsule 110, 210.

### 3. Example Capsule

FIGS. 3A-3C depict an embodiment of the capsule 210 configured to be accelerated by a co-axial electromagnetic accelerator. FIG. 3A is an aspect view of the capsule 210. FIG. 3B is a cross-sectional view that also includes a conductive plate 330 adhered to the capsule 210 to assist in conveying current. FIG. 3C is a disassembled, cross-sectional view of the capsule 210. FIGS. 3A-3C are described together below.

The capsule 210 includes an outer shell 310 packed with an inner payload 340. The inner payload 340 can include, for instance, a quenching agent configured to dissipate thermal energy in a confinement chamber of a plasma fusion reactor. The capsule 210 also has a central aperture 320 that is configured to receive an inner rail electrode in a co-axial electromagnetic accelerator. The capsule 210 includes a trailing side 354 and a leading side 352 opposite the trailing side 354. As used herein, the trailing side 354 of the capsule 210 refers to the side of the capsule 210 relatively further from (e.g., distal) the exit point of the accelerator, when the capsule 210 is loaded in the acceleration chamber. The leading side 352 refers to the side of the capsule 210 relatively closer to (e.g., proximate) the exit point of the acceleration chamber, when the capsule 210 is loaded in the acceleration chamber. While the capsule 210 is being accelerated within the acceleration chamber, the trailing side 354 thus refers to the side of the capsule 210 that passes a given location in the acceleration chamber second, after the leading side 352 passes the same location.

The sidewalls of the capsule 210 include both an inner sidewall 370, which forms the boundary of the central aperture 320, and which interfaces with the inner co-axial rail electrode 224, and an outer sidewall 372, which interfaces with the outer co-axial rail electrode 222. The outer shell 310 may include both sidewalls 370, 372 and the trailing and leading sides 352, 354.

The capsule 210 may be at least approximately cylindrically symmetric about an axis 302 passing through the central aperture 320. For example, the capsule 210 may have an annular shape, such as a toroid. The capsule 210 may also be a hollow cylindrical shell, with an inner radius r₁ and an outer radius r₂, similar to the illustration in FIG. 3. The inner radius r₁ can define the boundary of the central aperture 320, and the inner sidewall 370, which interfaces with the inner co-axial rail electrode 224 when the capsule 210 is loaded in the accelerator 220. The outer radius r₂ can define the boundary of the outer sidewall 372, which interfaces with the outer co-axial rail electrode 222 when the capsule 210 is loaded in the accelerator 220. In some embodiments, the dimensions of r₁ may be about 0.5 to about 1.5 centimeters and the dimensions of r₂ may be about 1 to 3 centimeters.

The outer shell 310 can be coated with a conductive coating 312 along the trailing side 354, and an insulating coating 314 along the leading side 352. The conductive coating 312 provides a conduction path for the electrical currents that flow along the trailing side 354 of the capsule 210. The conductive coating 312 can thus direct current carried through the capsule 210 along the trailing side 354, as opposed to other locations. Additionally, the conductive coating 312 can prevent magnetic flux developed in the acceleration chamber from penetrating the capsule 210. By preventing magnetic flux from passing through the capsule 210, the conductive coating 312 on the trailing side 354 can thereby allow the capsule 210 to be accelerated by magnetic pressure created by the currents flowing between the rail electrodes 222, 224 near the trailing side 354 of the capsule 210.

Moreover, the insulating coating 314 can prevent current from flowing along the leading edge 352 of the capsule 210. During acceleration of the capsule 210, applying force from the rear (i.e., the trailing side 354), as opposed to the front (i.e., the leading side 352) prevents the capsule 210 from being pulled apart during acceleration. That is, currents conveyed along the leading side 352 may result in pulling forces that overcome the structural integrity of the outer shell 310 and thereby pull the capsule 210 apart, rather than accelerate the entire capsule 210 through the acceleration chamber.

As shown in FIG. 3B, the conductive coating 312 and/or insulating coating 314 can each be applied to the respective trailing side 354 and leading side 352 as well as partially overlapping onto the sidewalls of the capsule 210. Applying the conductive coating 312 to a portion of the sidewalls adjacent to the trailing side 354 can facilitate electrical connection with the conductive surfaces of the rail electrodes (e.g., the rail electrodes 222, 224) which slide across the sidewalls of the capsule 210 while the capsule 210 is being accelerated. The thickness of the conductive coating 312 can be some fraction of the thickness of the outer shell 310, such that the conductive coating 312 has a slightly greater radial extent than the outer shell 310. Such an arrangement can be used to ensure a robust electrical contact is maintained by the conductive coating 312 with the accelerator rail electrodes 222, 224.

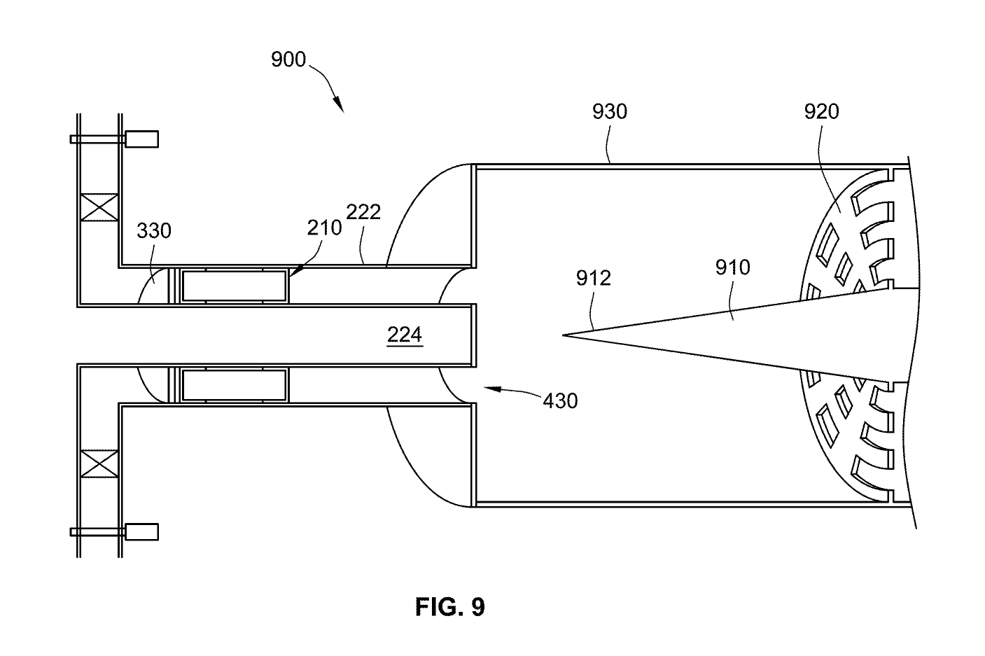

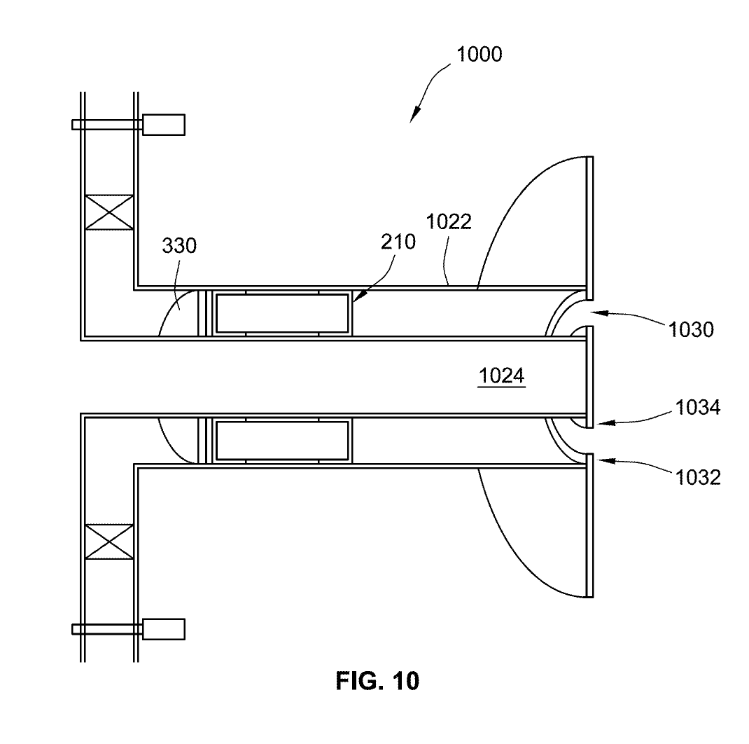

The capsule 210 may be assembled in two sections 362, 364, which are shown in FIG. 3C. Each of the sections 362, 364 may be fabricated as an open annular shell (i.e., respective sections of the outer shell 310), which are then packed with a payload material 340, such as a quenching agent. The two sections 362, 364 can then be bonded together by, for example, pressing or otherwise molding the two sections together. In some examples, the structural integrity of the outer shell 310 can be enhanced, after bonding the two sections 362, 364 to one another by baking the outer shell 310. For example, baking the outer shell 310 may result in annealing the two sections 362, 364 together. Generally, the structural strength of the outer shell 310 can be designed to withstand the acceleration forces in the accelerator, but not much more. Upon exiting the accelerator or during the final stages of acceleration, after the particulate matter has gained sufficient velocity (e.g., on the order of 1 km/s), the capsule 210 may fragment. Examples for facilitating fragmentation of the capsule are provided below in connection with FIGS. 9 and 10.

The quenching agent 340 packed in the outer shell 310 can be a material configured to interact with energetic plasma particles so as dissipate the thermal energy of the plasma. For instance, the quenching agent 340 may include particulate matter that interacts with the plasma by absorbing energy from plasma particles (e.g., in collision events), transitioning to an excited state, and then relaxing to a lower energy state by radiating away excess energy. The quenching agent can thereby convert thermal energy in the plasma to radiation, and thereby dissipate excess thermal energy in a confinement chamber of a plasma fusion reactor.

In an example, the materials used to form the capsule 210 can be materials intended to be injected into a reaction vessel, such as a confinement chamber of a plasma fusion reactor. The capsule 210 may be formed of materials including boron nitride, boron carbide, beryllium, lithium-oxide, lithium dioxide, carbon, alumina, and other suitable low atomic weight materials. For example, the outer shell 310 may be formed of boron nitride and/or boron carbide, and the quenching agent 340 packed in the outer shell 310 may include lithium-oxide and/or beryllium optionally bonded with particulates of carbon, such as a graphite powder. The conductive coating 312 may include conductive graphite, for example, and the insulating coating 314 may include alumina.

Other possibilities exist to create the capsule 210. For instance, the outer shell 310 may be formed of a thin polymeric material, which can then be packed with a desired quenching agent 340 and coated with a conductive layer. In examples employing a polymeric outer shell, the acceleration chamber may be pressurized with an inert gas to facilitate contact between the surfaces of the capsule 210 contact with the electrode surfaces.

Moreover, in some embodiments, rather than using an outer shell, the capsule 210 can be formed by mixing the desired impurity species (e.g., quenching agent) with a bonding agent, compression packing the capsule to create a desired form, and then baking the capsule in an oven to increase the structural rigidity. For example, graphite powder mixed with lithium-oxide as the bonding agent may be used.

Generally, the materials included in the capsule 210 may all be low atomic weight materials, such as materials with atomic weights less than Iron. Low atomic weight materials may be desired, because such materials can be efficiently removed from a plasma fusion reactor by a process that fully ionizes materials in the reactor and then pumps the fully ionized contaminants from the chamber. Moreover, in some cases, the materials included in the capsule 210 may be selected to be suited for particular confinement chambers, such as confinement chambers including coatings formed of lithium dioxide, beryllium, etc.

A conductive plate 330 is also shown in FIGS. 3A and 3B. The conductive plate 330 can be a flattened ring (e.g., a disk with a centrally located hole) bonded to the trailing side 354 of the capsule 210. The conductive plate 330 can facilitate current flow along the trailing side 354 of the capsule 210. The conductive plate 330 can thus be accelerated within the co-axial accelerator 220 and then be used to push the capsule 210 through the acceleration chamber. The conductive plate 330 can be sized to have substantially similar dimensions as the trailing side 354. Thus, the conductive plate 330 may have an inner lip 334 and an outer lip 332. The inner lip 334 can have a radius of curvature r₁ and the outer lip 332 can have a radius of curvature r₂ sized so as to allow the respective lips 332, 334 of the conductive plate 330 to contact (or at least nearly contact) the respective conductive surfaces of the co-axial rail electrodes 222, 224 while the conductive plate 330 is loaded in the acceleration chamber. In some examples, the conductive plate 330 may be formed of a material suitable for being injected into a plasma confinement chambers, such as conductive graphite and/or other low atomic weight materials. In other examples, the conductive plate 330 may be formed of another conductor, but be prevented from entering the plasma confinement chamber. For instance a cone may be situated adjacent the exit point of the accelerator to capture the plate 330 before entering the plasma, or the acceleration chamber may taper near the exit point to create a narrow channel sufficient to capture the plate 330 (e.g., by contact with one or both of the lips 332, 334) before entering the plasma while allowing the capsule 210 to continue on. Examples of such arrangements for capturing the conductive plate 330 are discussed further below in connection with FIGS. 9 and 10 below.

### 4. Co-Axial Electromagnetic Accelerator

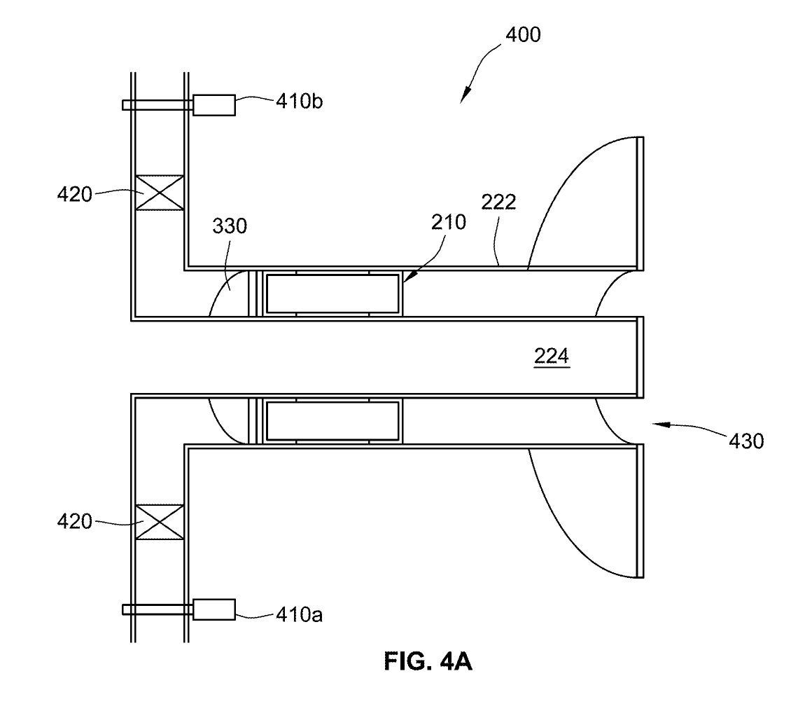

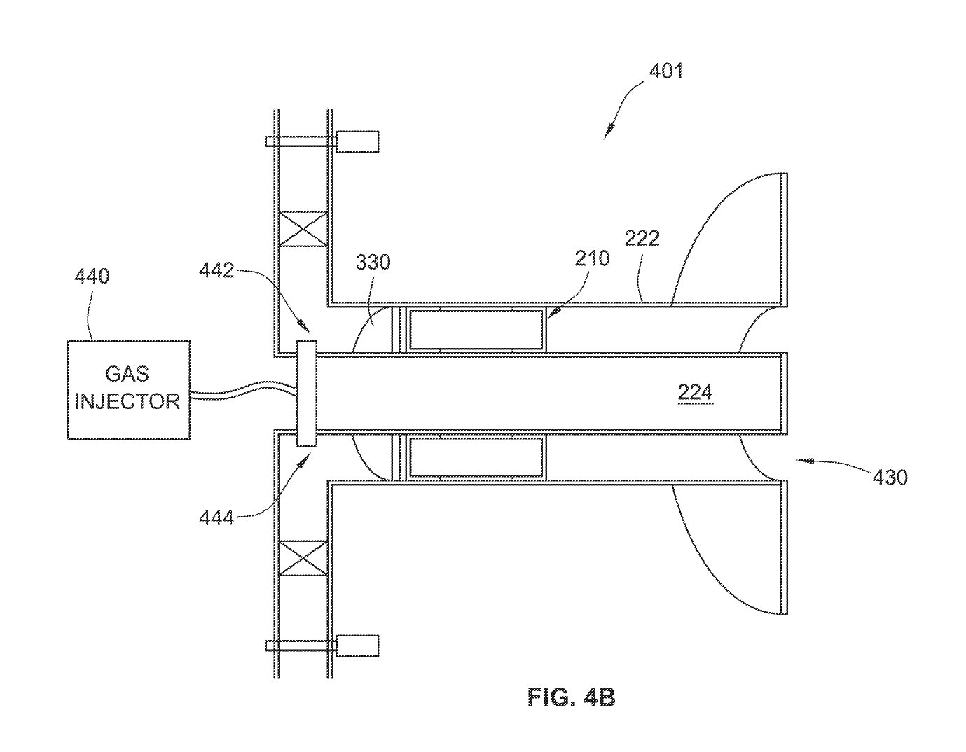

FIG. 4A depicts an example system 400 including an electromagnetic accelerator having co-axial rail electrodes 222, 224. The system 400 operates similarly to the system 200 described above in connection with FIG. 2. However, the system 400 also includes a flange 430 for mounting the accelerator to a reaction vessel, such as a confinement chamber of a plasma fusion reactor. The system 400 also includes at least one electrical insulator 420 to separate the two rail electrodes 222, 224. The insulator 420 may be, for instance a ceramic material such as alumina, that is arranged as a toroid to span the distance between the two flanges connected to the two rail electrodes 222, 224. Thus, the view in FIG. 4A shows two cross sections of the toroid-shaped insulator 420 at different locations. In addition to electrically isolating the two rail electrodes 222, 224, the insulator 420 may also be used to create a vacuum seal for the acceleration chamber and thereby prevent contaminants from entering the acceleration chamber (and any reaction vessels the accelerator is connected to). The diagram in FIG. 4A illustrates one such insulator 420, although any number of insulators may be used. For example, a second toroidal insulator with an inner radius larger than the outer radius of the insulator 420 may be placed between the two flanges of the rail electrodes 222, 224. In such an example the outer, larger insulator may also provide additional structural reinforcement to the arrangement and may be fabricated of a hard, strong composite material, such as G-10, for example. Moreover, the system 400 may include a housing or other supportive structure for mounting the two rail electrodes 222, 224, such as by connection to the respective flanges separated by the insulator 420.

The system 400 also includes electrical connectors 410a-b, which may be coaxial current feed cables for conveying the discharge current from the capacitor bank 140. Two such electrical connectors 410a-b are illustrated in FIG. 4A, although some embodiments may include more than two coaxial current feed cables, such as an example with ten coaxial current feed cables.

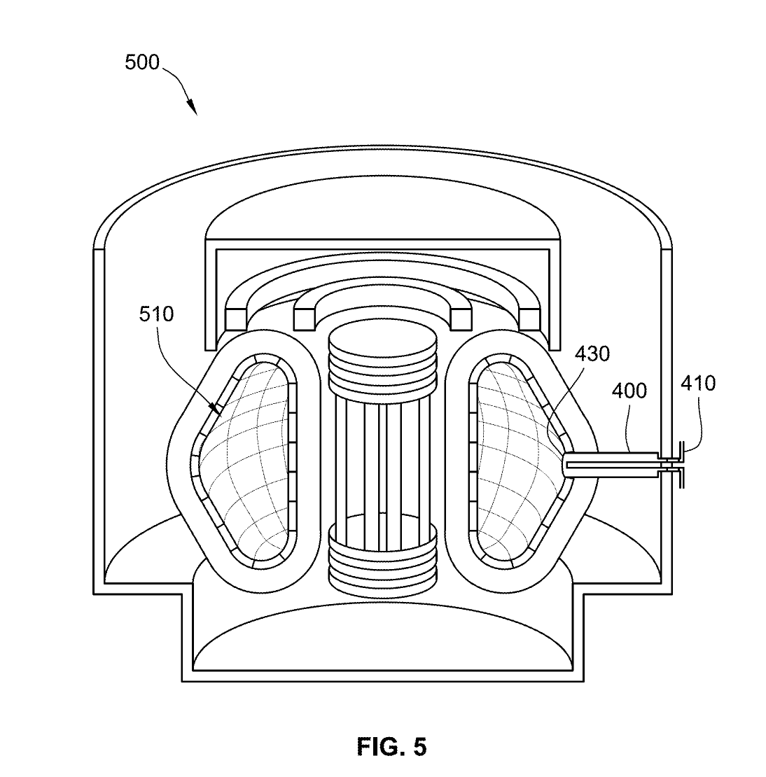

The flange 430 allows the accelerator 400 to be mounted to the side of a confinement chamber, which is shown for example purposes in FIG. 5 below. The flange may include one or more electrical insulators, seals, and the like suitable for joining the accelerator 400 to a port of a plasma confinement chamber. As shown in FIG. 5, the accelerator 400 can thus be used as an injector to inject the capsule 210 into the confinement chamber of a plasma fusion reactor.

The accelerator region (e.g., the length of the chamber in which the capsule undergoes acceleration) can be about 0.2 to 2.0 meters in length. Although, the length can be selected to achieve desired performance characteristics of the system 400. For instance, depending on the target plasma parameters, the length can be selected (along with parameters for the capsule 210, and the capacitor bank 140) to achieve desired responsiveness and/or injection speed.

When used as an injector for a plasma confinement chamber, the co-axial rail electrodes 222, 224 can be fabricated from tungsten, stainless steel, or another suitable conductor. Stainless steel may be coated with tungsten over the regions making contact with the capsule. Although, because the pulse duty of the accelerator is low, fabrication out of pure stainless steel is also a possibility.

The outer electrode 222 may be maintained at ground electric potential. The inner electrode 224 may be connected to the negative terminal of the capacitor bank 140, and the outer electrode 222 may be connected to the positive terminal of the capacitor bank 140 through a switch. Thus, the switch 150 described in connection with FIGS. 1 and 2 above, may be situated between the electrical connection to the outer electrode 222 and the positive terminal of the capacitor bank 140. The capacitor bank 140 is sized to provide sufficient current for a sufficient duration to accelerate the capsule 210 to a desired velocity. The electromagnetic forces on the trailing side of the capsule 210 (along the plate 330) result from the combination of current on the trailing side of the capsule 210 (and/or through the plate 330) and the magnetic fields that exist behind the capsule 210 as result of the current flowing on the surface of the inner rail 224. These electromagnetic forces urge the capsule 210 to accelerate toward the flange 430, to exit the accelerator 400 and be injected into the attached reaction chamber.

The flange 430 of the accelerator 400 is connected to a supporting structure that is connected to the confinement chamber, as shown in FIG. 5. The supporting structure may include suitable seals to form a vacuum seal with the confinement chamber. The length and diameter are dependent on the distance from the plasma in the confinement chamber.

FIG. 4B depicts an example system 401 including co-axial electromagnetic injector and a gas insertion system 440. The gas insertion system 440 includes one or more valves or other ports 442, 444 for injecting gas into the acceleration chamber near the conductive portion of the capsule 210. The gas insertion system 440 may be operated according to instructions from the controller 130, for example. The gas insertion system 440 may be operated to inject a small amount of gas into the acceleration chamber at a location near the conductive portion 312 of the capsule 210.

Gas can be injected just before (or coincident with) activating the accelerator by applying the electric potential from the capacitor bank 140 across the rail electrodes 222, 224. Once the potential is applied across the rail electrodes 222, 224, the injected gas is quickly ionized to generate a plasma near the conductive portion 312 of the capsule 210. Once generated, the plasma can convey current between the two rail electrodes 222, 224 and thereby facilitate current flow adjacent the conductive portion 312 of the capsule 210. In embodiments including the gas insertions system 440, the conductive plate 330 may be omitted, because the additional magnetic flux behind the capsule 210 provides additional magnetic pressure that urges the capsule 210 to accelerate out of the accelerator in order to release the magnetic flux. In particular, because the trailing side 354 of the capsule 210 includes the conductive coating 312, the magnetic flux contributed by the current-carrying plasma cannot penetrate the capsule 210 and therefore builds a magnetic pressure urging the capsule to move away from the plasma (i.e., toward the flange 430) so as to relax the injected magnetic flux carried by the plasma. Moreover, the plasma created by the injected gas may facilitate partial ablation of the capsule 210 along the trailing side 354, which may itself contribute to the magnetic pressure that accelerates the capsule 210.

### 5. Example Operation

FIGS. 5-8 illustrate operation of an electromagnetic injector to quench an instability in a magnetic fusion reaction vessel. FIG. 5 depicts a plasma fusion reactor system 500 having a confinement chamber 510 to which the accelerator 400 is connected by the flange 430. Electrical connectors 410 for the rail electrodes 222, 224 in the accelerator 400 are connected to the capacitor bank 140, which is configured to apply a potential to the rail electrodes in response to suitable instructions 132 from the controller 130, which may operate the switch 150, for example. The accelerator 400 can thus inject a capsule into the confinement chamber 510 in response to a determination made in the controller 130.

While only one accelerator is shown, some examples may include multiple accelerators connected to the confinement chamber at different locations to be able to inject capsules from multiple locations simultaneously. For example, there may be two, three, or four such similar injectors connected to different locations of the confinement chamber 510. In some cases, multiple injectors can be at least approximately equally spaced about the toroidal confinement chamber 510.

Moreover, some examples may employ a cartridge loading system so that capsules can be inserted as required. In such a cartridge loading a multiple-chamber injector system, the entire inner and outer rail electrodes may be part of an assembly, and a number of similar assemblies may be situated inside a cylindrical chamber that rotates to allow each assembly to make contact with the current feed from the capacitor bank 130. Thus, multiple injector assemblies can be pre-loaded with capsules, and, upon activating one of the injectors, the next assembly can be moved into position to be ready to inject another capsule without needing to manually re-load the assembly for the same set of rail electrodes.

In some embodiments, the confinement chamber 510 holds an ionized gas (plasma). To retain the plasma, the confinement chamber may include seals (gaskets) to create an air tight seal between any boundaries between solid components in the walls of the confinement chamber. For example, any such boundaries may be sealed with one or more gasket seals formed with a fluoroelastomer and/or with metallic gaskets. The confinement chamber 510 has chamber walls formed of a magnetic flux conserving material. The chamber walls can include a conductive material, such as a copper chromium alloy, to prevent open magnetic field lines from penetrating the chamber walls. In some examples, induced magnetic fields in the chamber walls prevent magnetic flux from penetrating the chamber walls.

The plasma confinement system 500 can also include one or more sensors, and associated processing equipment configured to dynamically detect instabilities in the plasma confinement chamber 510. Such instabilities may be indicated by thermal conditions indicating the confinement chamber control system is failing to regulate the conditions in the plasma. Such instabilities may be detected with a warning time of approximately 10 milliseconds, for example. In some embodiments of the present disclosure, a particulate matter accelerator can be used to quench unstable thermal activity in a confinement chamber of a plasma fusion reactor by injecting a capsule including quenching impurities to quench the thermal energy in the plasma through radiative energy loss.

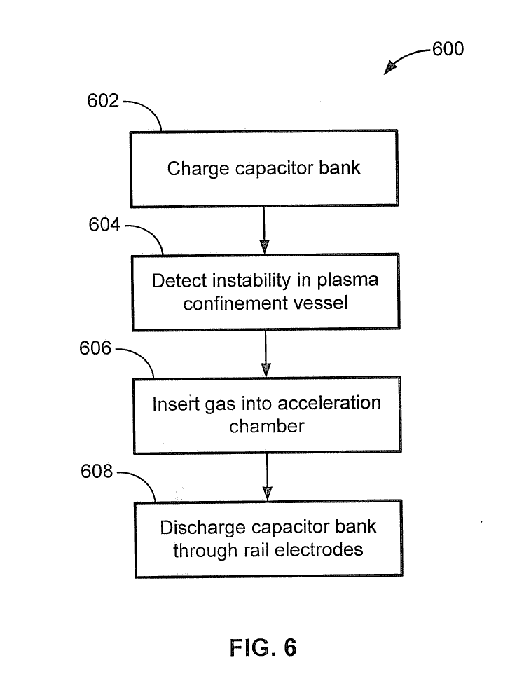

FIG. 6 is a flowchart of an example process 600 for quenching thermal activity in the plasma confinement system 500. A capacitor bank is charged (602). For example the capacitor bank 140 can be connected to one or more power sources to charge an electric potential on the capacitor bank 140. The charging of block 602 may be carried out routinely or in response to instructions from the controller 130. Once the capacitor bank 140 is charged, the accelerator 400 is ready to inject a capsule into the confinement chamber. An instability in the plasma confinement chamber 510 is detected (604). For example, one or more diagnostic systems associated with the plasma confinement system 500 may operate to detect an instability, and then send an indication of the instability to the controller 130. Upon detecting the instability, the accelerator 400 is activated by the controller 130. Thus, block 604 may include receiving an indication of an instability condition and/or receiving an indication to activate the accelerator 400. Gas may be inserted into the acceleration chamber (606). For example, the gas insertion system 440 described in connection with the system 401 shown in FIG. 4B may be used to insert gas into the acceleration chamber at a location near a conductive portion of the capsule. The accelerator 400 is then activated by discharging the capacitor bank 140 through the rail electrodes 222, 224 of the accelerator 400 (608). Block 608 may include closing the switch 150 so as to apply the potential charged on the capacitor bank to the rail electrodes and thereby cause current to flow between the rail electrodes and through the capsule 210, which current causes an electromagnetic force to be applied to the capsule 210 that urges the capsule 210 to accelerate out of the accelerator 400 and into the confinement chamber 510. It is noted that blocks 606 and 608 may optionally be performed in parallel.

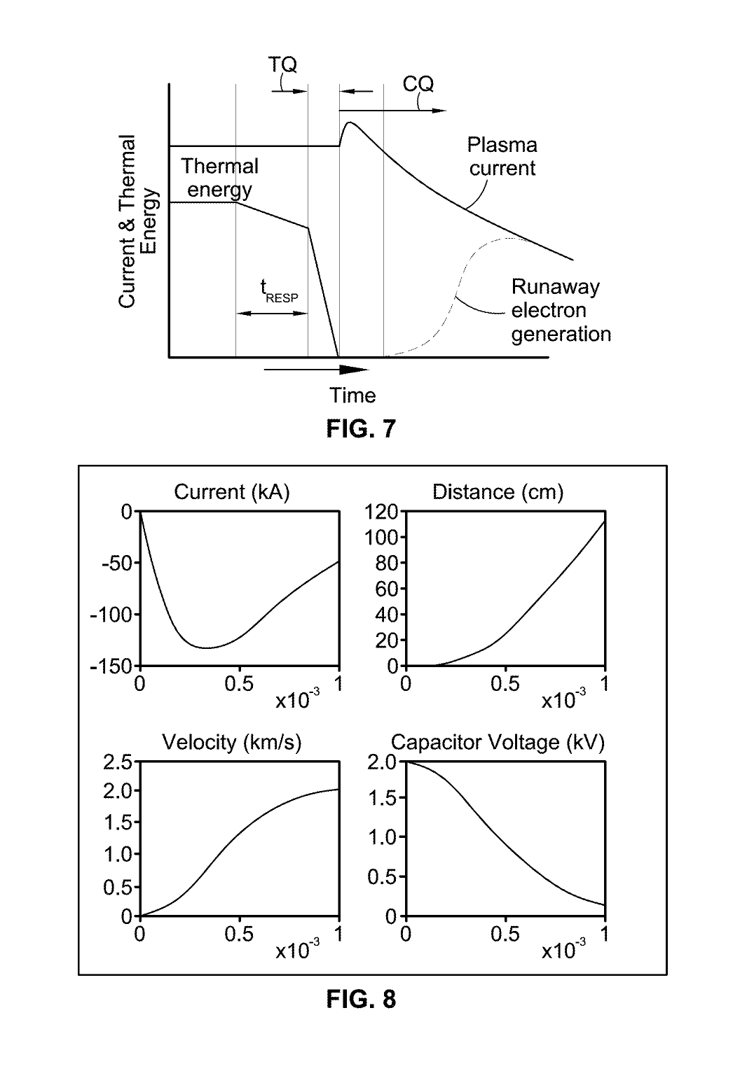

FIG. 7 depicts the dissipation of plasma current and thermal energy during an example operation of the process 600. After the detection of an impending disruption, the time available for a disruption mitigation system to respond, tᵣₑₛₚ may be less than 10 ms for some disruptions. Considerably more time is available for controlling the plasma current, which is indicated by the current quench phase (CQ) in FIG. 7. After the disruption is mitigated, by, for example, operation of the process 600, the plasma-stored energy begins to decrease. After the impurities delivered in the capsule 210 reach the plasma, rapid mixing initiates the thermal quench phase during which most of the thermal energy of the plasma is reduced, which is indicated by the thermal quench phase (TQ) in FIG. 7. Much of the poloidal magnetic energy still remains. An increase in the plasma induction, due to shrinking of the plasma, causes an initial spike in the plasma current. This is followed by decay of plasma current. The decaying plasma current may amplify seed electrons already present in the discharge to a significant level of runaway current.

FIG. 8 depicts various quantities in the system 600 during operation of the process 600. The top left box shows the discharge current from the capacitor bank, and thus the current between and through the rail electrodes 222, 224. The top right box shows the displacement of the capsule 210 as it accelerates through the acceleration chamber. The bottom left box shows the velocity of the capsule 210 as it accelerates through the acceleration chamber. The bottom right box shows the voltage of the capacitor bank 140 as the capacitor bank 140 discharges through the rail electrodes 222, 224. The example values shown in FIG. 8 show that a 15 centimeter long accelerator should be able to achieve a velocity of 1 km/s in less than 0.5 milliseconds.

The table below presents example parameter values for an electromagnetic injector system 400 connected to a plasma confinement chamber 510. It is noted that the values included below are provided for purposes of example and not limitation.

| | Example 1 | | Example 2 | |
|---|---|---|---|---|
| Injector Parameters | | | | |
| Number of Injectors | 1 | | 2-3 | |
| Accelerator Length | 0.3 | m | 0.7-2 | m |
| Capacitor bank Voltage | 2 | kV | 2 | kV |
| Bank Capacitance | 50 | mF | 100 | mF |
| Bank Energy | 100 | kJ | 200 | kJ |
| External Inductance | 2 | μH | 4 | μH |
| Capsule Parameters | | | | |
| Capsule Velocity | 1 | km/s | 1.5-2 | km/s |
| Inner/Outer Radii | 0.5/1 | cm | 0.5/1 | cm |
| Length | 1-2 | cm | 1-2 | cm |
| Volume | 1-2 | cc | 3-6 | cc |
| Mass | 2.8 | g | 5.5 | g |

| | | |
|---|---|---|
| No. of C atoms | 1.5E+23 | 3.7E+23 |
| Equivalent Electron Content | 9.2E+23 | 1.5E+24 |

### 6. Capsule Fragmentation

FIG. 9 depicts a fragmentation cone 910 situated to receive the injectable capsule 210. The fragmentation cone 910 includes a point 912 that is situated proximate to the exit point from the accelerator so as to receive the central aperture of the capsule 210. In some examples, the fragmentation cone 910 can share an axis of cylindrical symmetry with the two rail electrodes 222, 224. Upon emerging from the accelerator, the capsule 210 fragments upon impact with the fragmentation cone 910. The capsule 210 may impact the fragmentation cone 910 in a symmetric manner such that the fragmented materials are substantially evenly dispersed. The fragmentation cone 910 is attached to a support structure 930 using radial bars 920 so that most of the region in the front end of the support structure 930 is open to allow the fragmented capsule and the entrained powder to enter the reaction vessel. The radial bars 920 may be situated near a port to the confinement chamber 510, for example.

In some examples, the fragmentation cone 910 and/or radial support structure 920 may also be used to capture the conductive plate 330. For example, the fragmentation cone 910 may be used to prevent the plate 330 from entering the confinement chamber 510.

The fragmentation cone 912 may be fabricated from a dense strong material so as to absorb the impact of the capsule 210 and also to shield the main accelerator from streaming neutrons. In some examples, tungsten may be used. The angle of the fragmentation cone 910 (i.e., the acute angle of the point 912) can be selected based on the location of the fragmentation cone 910 with respect to the edge of the plasma and the desired angle for dispersing the particulate matter into the plasma.

FIG. 10 depicts a narrowed channel 1030 at an end of the acceleration chamber from which the capsule 210 emerges. The narrowed channel 1030 can be formed by tapering/flaring the side walls of the acceleration chamber. For example, the narrowed channel 1030 may be formed by a tapered feature 1032 on a tapered outer rail electrode 1022 and/or a flared feature 1034 on a flared inner rail electrode 1024. The tapered feature 1032 can include a portion of the outer rail electrode 1022 that bends inward, toward the inner rail electrode 1024, near the end of the acceleration chamber from which the capsule 210 emerges. Similarly, the flared feature 1034 can include a portion of the inner rail electrode 1024 that bends outward, toward the outer rail electrode 1022, near the end of the acceleration chamber from which the capsule 210 emerges.

The narrowed channel 1030 is thus a region in which the cross sectional area of the acceleration chamber, transverse to the direction of acceleration, is relatively less than in the rest of the acceleration chamber. Generally, the narrowed channel 1030 can be formed from any combination of the tapered feature 1032, on the outer rail electrode 1022, and/or the flared feature 1034, on the inner rail electrode 1024. Passing the capsule 210 through the narrowed channel 1030 fragments the capsule 210 because the cross sectional area of the capsule 210 is greater than the cross sectional area of the narrowed channel and so portions of the capsule 210 collide with one or more of the tapered feature 1032 and/or the flared feature 1034, which collision breaks apart the capsule.

Furthermore, the narrowed channel 1030 can be used to capture the conductive plate 330. For example, the outer diameter of the capsule 210 can be made less than the outer diameter of the plate 330 (at the outer lip 332) such that the capsule 210 is able pass freely through the narrowed channel 1030. However, the plate 330 is captured by contact between the outer lip 332 and/or inner lip 334 of the plate 330 with the tapered feature 1032 and/or flared feature 1034 and remains in the acceleration chamber while the capsule 210 continues on (e.g., to enter the plasma confinement chamber 510). Additionally or alternatively, the narrow channel 1030 may include one or more radial bars (or “spokes”) formed of insulating materials connected between the co-axial electrodes 1022, 1024, which combine to create a grating to fragment the capsule 210 and/or capture the plate 330 by contact with such grating.

### 7. Computer Readable Medium

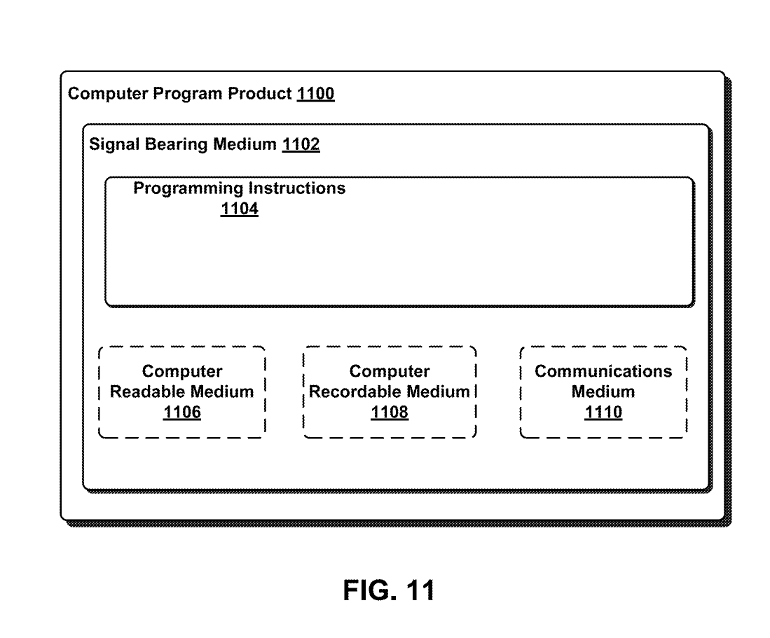

FIG. 11 depicts a non-transitory computer-readable medium configured according to an example embodiment. In example embodiments, the example system can include one or more processors, one or more forms of memory, one or more input devices/interfaces, one or more output devices/interfaces, and machine-readable instructions that when executed by the one or more processors cause the system to carry out the various functions, tasks, capabilities, etc., described above.

As noted above, in some embodiments, the disclosed techniques can be implemented by computer program instructions encoded on a non-transitory computer-readable storage media in a machine-readable format, or on other non-transitory media or articles of manufacture (e.g., executable program logic stored on a memory of the controller 130 in FIGS. 1-2). FIG. 11 is a schematic illustrating a conceptual partial view of an example computer program product that includes a computer program for executing a computer process on a computing device, arranged according to at least some embodiments presented herein.

In one embodiment, the example computer program product 1100 is provided using a signal bearing medium 1102. The signal bearing medium 1102 can include one or more programming instructions 1104 that, when executed by one or more processors can provide functionality or portions of the functionality described above with respect to FIGS. 1-10. In some examples, the signal bearing medium 1102 can be a computer-readable medium 1106, such as, but not limited to, a hard disk drive, a Compact Disc (CD), a Digital Video Disk (DVD), a digital tape, memory, etc. In some implementations, the signal bearing medium 1102 can be a computer recordable medium 1108, such as, but not limited to, memory, read/write (R/W) CDs, R/W DVDs, etc. In some implementations, the signal bearing medium 1102 can be a communications medium 1110, such as, but not limited to, a digital and/or an analog communication medium (e.g., a fiber optic cable, a waveguide, a wired communications link, a wireless communication link, etc.). Thus, for example, the signal bearing medium 1102 can be conveyed by a wireless form of the communications medium 1110.

The one or more programming instructions 1104 can be, for example, computer executable and/or logic implemented instructions. In some examples, a computing device such as the controller 130 of FIGS. 1-2 is configured to provide various operations, functions, or actions in response to the programming instructions 1104 and/or executable instructions conveyed to a processor or processors by one or more of the computer readable medium 1106, the computer recordable medium 1108, and/or the communications medium 1110.

The non-transitory computer readable medium could also be distributed among multiple data storage elements, which can be remotely located from each other. The computing device that executes some or all of the stored instructions can be a handheld device, such as a personal phone, tablet, etc. Alternatively, the computing device that executes some or all of the stored instructions can be another computing device, such as a server.

### 8. Conclusion

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. A system comprising:
at least one electromagnetic accelerator including: (i) a first rail electrode, (ii) a second rail electrode, and (iii) an acceleration chamber having sidewalls formed at least in part by the first and second rail electrodes;
a capsule configured to be loaded in the acceleration chamber of the at least one electromagnetic accelerator so as to be disposed between the first and second rail electrodes, wherein the capsule includes a conductive portion arranged so as to convey electrical current between the first rail electrode and the second rail electrode while the capsule is loaded; and
a control system configured to (i) receive an indication to activate the at least one electromagnetic accelerator, and (ii) responsive to receiving the indication, cause an electric potential to be applied between the first rail electrode and the second rail electrode such that, when the capsule is loaded, current flows from the first rail electrode to the second electrode, and through the conductive portion of the capsule, thereby causing the capsule to accelerate within the acceleration chamber.

2. The system according to claim 1, wherein the capsule is configured to accelerate within the acceleration chamber due to an electromagnetic interaction between magnetic fields in the acceleration chamber induced by the current flowing through at least one of the first or second rail electrodes and current flowing through the conductive portion of the capsule.

3. The system according to claim 1, wherein the system is connected to a reaction vessel and is arranged such that activating the at least one electromagnetic accelerator accelerates the capsule into the reaction vessel.

4. The system according to claim 3, wherein the reaction vessel is a plasma confinement region for a magnetic fusion reactor, and wherein the control system is configured to activate the electromagnetic accelerator in response to detecting an instability within the plasma confinement region.

5. The system according to claim 4, wherein the injectable capsule includes a quenching agent configured to interact with plasma particles so as to absorb thermal energy of the plasma particles and radiate away excess energy, thereby decreasing the thermal energy within the plasma confinement region.

6. The system according to claim 5, wherein the quenching agent includes at least one of lithium-oxide or graphite.

7. The system according to claim 3, wherein the at least one electromagnetic accelerator comprises two or more electromagnetic accelerators, wherein each electromagnetic accelerator is connected to the reaction vessel and configured to accelerate respective capsules into the reaction vessel in response to the control system receiving the indication to activate.

8. The system according to claim 7, wherein the two or more electromagnetic accelerators are connected to the reaction vessel in an arrangement that is at least approximately equally spaced around the reaction vessel.

9. The system according to claim 1, further comprising:
an energy storage module connected to at least one of the first and second rail electrodes and configured to be charged with the electric potential; and
a switch configured to discharge the energy storage module through the first and second rail electrodes, and the conductive portion of the capsule, and thereby apply the electric potential between the first and second rail electrodes; and
wherein the control system is configured to activate the at least one electromagnetic accelerator by operating the switch.

10. The system according to claim 9, wherein the energy storage module includes a capacitor bank.

11. The system according to claim 1, wherein the conductive portion of the capsule is arranged so as to simultaneously electrically contact both the first and second rail electrodes while the capsule is loaded in the acceleration chamber.

12. The system according to claim 1, wherein the conductive portion of the capsule includes a conductive plate configured to extend transverse to the first and second rail electrodes while the capsule is loaded in the acceleration chamber.

13. The system according to claim 12, further comprising at least one of a fragmentation cone or a fragmentation channel that interfaces with the conductive plate upon the capsule emerging from the acceleration chamber so as to retain the conductive plate while the capsule continues away from the acceleration chamber.

14. The system according to claim 1, wherein the capsule includes an outer shell, and wherein the conductive portion of the capsule includes a conductive film coated on the outer shell at least along a trailing edge of the capsule that is transverse to the sidewalls of the acceleration chamber while the capsule is loaded.

15. The system according to claim 14, wherein the outer shell is further coated with an insulating film along a leading edge of the injectable capsule opposite the trailing edge.

16. (canceled)

17. The system according to claim 15,
wherein the outer shell includes at least one of Boron Carbide, Boron Nitride, or salts thereof,
wherein the conductive film includes conductive graphite or salts thereof, and
wherein the insulating film includes alumina or salts thereof.

18. (canceled)

19. The system according to claim 1,
wherein the first rail electrode includes an inner rail extending along a length of the acceleration chamber and having an outer conductive surface, and
wherein the second rail electrode includes an outer rail extending along the length of the acceleration chamber and having an inner conductive surface that faces the outer conductive surface of the inner rail.

20. The system according to claim 1, wherein the first and second rail electrodes are at least approximately cylindrically symmetric about a common axis extending along a length of the acceleration chamber.

21. The system according to claim 20,
wherein the first rail electrode includes an inner cylindrical conductor with an outer conductive surface that extends along the length of the acceleration chamber,
wherein the second rail electrode includes an outer cylindrical shell with an inner conductive surface that faces the outer conductive surface of the first rail electrode, and
wherein the first and second rail electrodes are situated such that the spacing between the outer conductive surface of the first electrode rail and the inner conductive surface of the second rail electrode is substantially constant along the length of the acceleration chamber.

22. The system according to claim 1,
wherein the first and second rail electrodes are situated in a co-axial arrangement, and
wherein the capsule includes an aperture to receive an inner one of the first and second co-axial rail electrodes when the capsule is loaded.

23. The system according to claim 19, wherein the capsule is a hollow, cylindrically-symmetric shell with an inner side wall and an outer side wall configured such that, while the capsule is loaded in the acceleration chamber, the inner side wall contacts the first rail electrode while the outer sidewall contacts the second rail electrode.

24. The system according to claim 19, wherein the capsule is toroidally shaped with a central aperture configured to receive the first rail electrode while the capsule is loaded in the acceleration chamber.

25. The system according to claim 1, further comprising a fragmentation cone having a point situated to receive a central aperture of the capsule, upon the capsule being accelerated out of the acceleration chamber, such that the capsule is fragmented in response to colliding with the fragmentation cone.

26. The system according to claim 1, wherein the first and second rail electrodes are arranged such that the acceleration chamber includes a fragmentation channel near an end of the acceleration chamber from which the injectable capsule emerges, wherein the fragmentation channel is formed by a separation distance between the first and second rail electrodes being smaller, in the fragmentation channel, than in other regions of the acceleration chamber, such that the capsule is fragmented in response to passing through the fragmentation channel.

27-29. (canceled)

30. The system according to claim 1,
further comprising a gas insertion system configured to insert gas into the acceleration chamber at a location proximate the conductive portion of the capsule, when the capsule is loaded, and
wherein the control system is further configured to cause the gas insertion system to insert gas into the acceleration chamber in response to receiving the indication such that, upon applying the electric potential between the first and second rail electrodes, the gas is energized to form a plasma that conveys current between the first and second rail electrodes proximate the conductive portion of the capsule.

31. A method comprising:
receiving an indication to activate at least one electromagnetic accelerator including (i) a first rail electrode, (ii) a second rail electrode, and (iii) an acceleration chamber having sidewalls formed at least in part by the first and second rail electrodes; and
responsive to receiving the indication, activating the at least one electromagnetic accelerator by causing an electric potential to be applied between the first and second rail electrodes such that current flows from the first rail electrode to the second electrode, and through a conductive portion of a capsule configured to be loaded in the acceleration chamber so as to be disposed between the first and second rail electrodes, thereby causing the capsule to accelerate within the acceleration chamber.

32-40. (canceled)

41. A non-transitory computer-readable medium storing instructions that, when executed by one or more processors in a computing device, cause the computing device to perform operations, the operations comprising:
receiving an indication to activate at least one electromagnetic accelerator including (i) a first rail electrode, (ii) a second rail electrode, and (iii) an acceleration chamber having sidewalls formed at least in part by the first and second rail electrodes; and
responsive to receiving the indication, activating the at least one electromagnetic accelerator by causing an electric potential to be applied between the first and second rail electrodes such that current flows from the first rail electrode to the second electrode, and through a conductive portion of a capsule configured to be loaded in the acceleration chamber so as to be disposed between the first and second rail electrodes, thereby causing the capsule to accelerate within the acceleration chamber.

42-43. (canceled)
